(19) United States
(12) Patent Application Publication
(10) Pub. No.: US 2015/0079545 A1
(43) Pub. Date: Mar. 19, 2015

(54) SYSTEMS AND METHODS FOR AUTOMATED FLIGHT INSTRUCTION AND CERTIFICATION

(71) Applicant: Thomas R. Kurtz, Ft. Myers, FL (US)

(72) Inventor: Thomas R. Kurtz, Ft. Myers, FL (US)

(21) Appl. No.: 14/464,190

(22) Filed: Aug. 20, 2014

Related U.S. Application Data
(60) Provisional application No. 61/878,122, filed on Sep. 16, 2013.

(51) Int. Cl. G09B 9/08; G06K 9/00; G06F 21/32

(52) U.S. Cl. CPC G09B 9/08; G06F 21/32; G06K 9/00288
USPC 434/30

(57) ABSTRACT

A system and method for providing certification of a pilot's use of a flight simulator is presented. The method includes recording flight data from a flight simulator while a pilot performs flight tasks of a flight syllabus, receiving a photo of the pilot, and generating a forensic record of the performance of flight tasks on the simulator by the pilot. The method further includes authenticating the identity of the pilot and evaluating the performance of the flight tasks by the pilot against an expected flight path and range of acceptable instrument outputs. The method further includes providing a written record to the pilot certifying successful completion of the flight syllabus on the flight simulator. The method optionally provides real-time flight guidance during performance of the flight tasks by the pilot. The system includes a virtual flight data recorder and virtual flight instructor system for performing the method.

### REFERENCE TO RELATED APPLICATIONS

This application claims priority to U.S. Provisional Patent Application No. 61/878,122 filed on 16 Sep. 2013, which is herein incorporated by reference in its entirety.

### TECHNICAL FIELD

Embodiments of the technology relate, in general, to automated flight instruction and certification for pilots, and in particular to systems and methods that allow pilots, including instrument-rated pilots, to record and obtain certification for recency of flight experience, aeronautical experience, and flight training performed on a flight simulator without requiring a flight instructor to be physically present to certify the recency of flight experience, aeronautical experience, or flight training.

### SUMMARY OF THE INVENTION

In an embodiment, a computer-implemented method of certifying flight training can include recording flight data from a flight simulator while a pilot performs flight tasks of flight syllabus, obtaining a photo of the pilot who performs the flight tasks, and generating a forensic record that includes the flight data and the photo, and which can include other data as well. The method further includes biometrically authenticating the pilot using the photo and evaluating the pilot's performance of the flight tasks using a set of rules and acceptable performance metrics for the flight task. The method determines that the flight training in the flight syllabus successfully completed based at least in part on the successful biometric authentication of the pilot and the outcome of the evaluation of the pilot's performance of the flight tasks. The method can further include obtaining, and confirming the validity of, Federal Aviation Administration (FAA) compliance information for the flight simulator, such as an FAA Letter of Authorization (LOA) indicating that the simulator meets all limitations and contingencies for the flight training, or compliance data associated with a compliance screen of the flight simulator for example using a screen capture of the compliance screen. The successful completion of the flight training can also be based upon whether the validity of the flight simulator compliance information can be confirmed. Biometrically authenticating the pilot can comprise comparing the photo of the pilot with a picture of the pilot present in one or more FAA-acceptable forms of identification, such as the pilot's driver license. The method can further include obtaining electronic records, such as scanned documents, of the pilot's FAA pilot certificate that includes the pilot certification number, an FAA Flight Medical certificate for the pilot, and the pilot's driver license. The identity of the pilot is further authenticated using one or more of the obtained electronic records, for example by locating a record for the pilot in an FAA Airman Database using the pilot's name or other identifying indicia such as the pilot certificate number. In various configurations, the flight simulator can be an FAA-approved Aviation Training Device (ATD), an FAA-approved Flight Training Device (FTD), or an FAA-approved Full Flight Simulator (FFS). The method can include obtaining a flight syllabus that includes one or more instructions for providing real-time guidance to the pilot during the pilot's performance of one or more flight tasks. The method can include providing the guidance to the pilot when the pilot operates the flight simulator outside of one or more flight parameters associated with the flight task.

In an embodiment, a flight training certification system includes a virtual flight data recorder that is configured to record data from a flight simulator during the performance of flight tasks of a flight syllabus by a pilot, and generate a forensic record that includes at least the flight data and a photo of the pilot, among other suitable data. The flight training certification system further includes a camera configured to take the photo. The flight training certification system further includes a virtual flight instructor system that is configured to authenticate the identity of the pilot using the photo and possibly other information, evaluate the pilot's performance of the flight tasks of the flight simulator using a set of rules and performance metrics, determine whether a flight task has been successfully completed based on successful authentication of the pilot and the evaluation of the pilot's performance of the flight task, and provide a written record certifying completion of a flight training exercise based at least in part on the successful completion of the flight task of the flight syllabus by the pilot. The virtual flight instructor system can be configured to receive, and confirm the validity of, FAA compliance information, such as an FAA Letter of Authorization (LOA) for the flight simulator, that shows that the flight simulator meets all of the limitations and contingencies in compliance with the FAA requirements, or compliance data associated with a compliance screen of the flight simulator for example using a screen capture of the compliance screen. The successful completion of the flight training can be based upon the successful confirmation of the validity of the FAA compliance information. The virtual flight instructor system can be configured to authenticate the identity of the pilot using one or more FAA acceptable form of identification such as the pilot's driver license. The system can receive electronic records, such as scanned documents, of the pilot's FAA pilot certificate that includes the pilot certification number, an FAA Flight Medical certificate for the pilot, and the pilot's driver license. The identity of the pilot can be authenticated using one or more of the obtained electronic records, for example by locating a record for the pilot in an FAA Airman Database using the pilot's name or the pilot certificate number. The system can include a flight simulator such as an FAA-approved Aviation Training Device (ATD), an FAA-approved Flight Training Device (FTD), and an FAA-approved Full Flight Simulator (FFS). The system can include a virtual flight instruction means configured to obtain a flight syllabus that includes one or more instructions for providing real-time guidance to the pilot during the pilot's performance of one or more flight tasks, and provide the real-time guidance. The guidance can be provided to the pilot when the pilot operates the flight simulator outside of one or more flight parameters associated with the flight task

In an embodiment, a non-transitory computer readable medium having instructions stored thereon can be executed by one or more processors and cause the processors to record flight data from a flight simulator during performance of flight tasks of a flight syllabus by a pilot, receive a photo of the pilot who performed the flight tasks, receive one or more electronic records that can include an FAA Letter of Authorization (LOA), FAA documentation associated with the flight simulator, and a screenshot of the compliance screen of the flight simulator, and generate a forensic record that includes at least the flight data, the LOA and compliance screen for the flight simulator, and the photo of the pilot. The instructions further cause the processors to validate the LOA for the flight simulator, and authenticate the identity of the pilot using biometric confirmation of the photo using an FAA-acceptable form of identification, or a record associated with the pilot in an FAA Airman Database. The instructions further cause the processors to evaluate the performance of the flight tasks against an expected flight path and instrument outputs for the flight tasks, and send a written record based at least in part on the outcomes of the validate, authenticate, and evaluate operations. The instructions can further cause the processors to receive a flight syllabus that includes one or more instructions for providing real-time guidance to the pilot during performance of the flight tasks, and providing the real-time guidance to the pilot when the pilot performs the flight tasks such that one or more of the instrument outputs are different from an expected range of outputs for the flight task.

### BRIEF DESCRIPTION OF THE DRAWINGS

The present disclosure will be more readily understood from a detailed description of some example embodiments taken in conjunction with the following figures:

FIG. 1 depicts an example automated flight instruction system, according to one embodiment.

FIG. 2 depicts an example computing device, according to one embodiment.

FIG. 3 depicts example operations of an automated flight instruction system, according to one embodiment.

FIG. 4 depicts example operations of a virtual flight data recorder, according to one embodiment.

FIG. 5 depicts example operations of a virtual flight instructor module, according to one embodiment.

FIG. 6 depicts example operations of a virtual flight instructor system, according to one embodiment.

FIG. 7 depicts an example scoring profile of a virtual flight instructor system, according to one embodiment.

FIG. 8 depicts an example report of a virtual flight instructor system, according to one embodiment.

### DETAILED DESCRIPTION

Various non-limiting embodiments of the present disclosure will now be described to provide an overall understanding of the principles of the structure, function, and use of automated flight instruction and certification systems and methods disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Described herein are example embodiments of flight instruction and certification systems and methods that allow users, such as Federal Aviation Administration (FAA) instrument-rated pilots, pilots in training, and pilots in general to receive certification for recency of flight experience, aeronautical experience, or flight instruction and training on flight simulators and flight training equipment without requiring flight instructors to be present at the time that the recency of flight experience, aeronautical experience, or flight instruction and training is performed. The systems and methods presented eliminates the need for a pilot to have a flight instructor, such as an FAA certified flight instructor (CFI), physically present to observe the time and content of the pilot's flight simulator experience and training. The systems and methods record the flight and instrument data from the flight simulator and generate a forensic record that can be used to verify the pilot's recency of flight experience, aeronautical experience, or training. The forensic record allows the pilot to log simulator time that otherwise might not count toward the pilot's recency of flight experience or aeronautical experience mandated by the FAA. The described methodologies can be used to authenticate the pilot's identity, validate that the flight simulator used by the pilot was in compliance with FAA standards, produce a forensic record of the pilot's flight, perform a review of the pilot's flight, and provide real-time guidance to the pilot based on the pilot's performance of the flight tasks of the flight syllabus. Providing real-time guidance to the pilot during the simulated flight can result in increased proficiency of the pilot.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

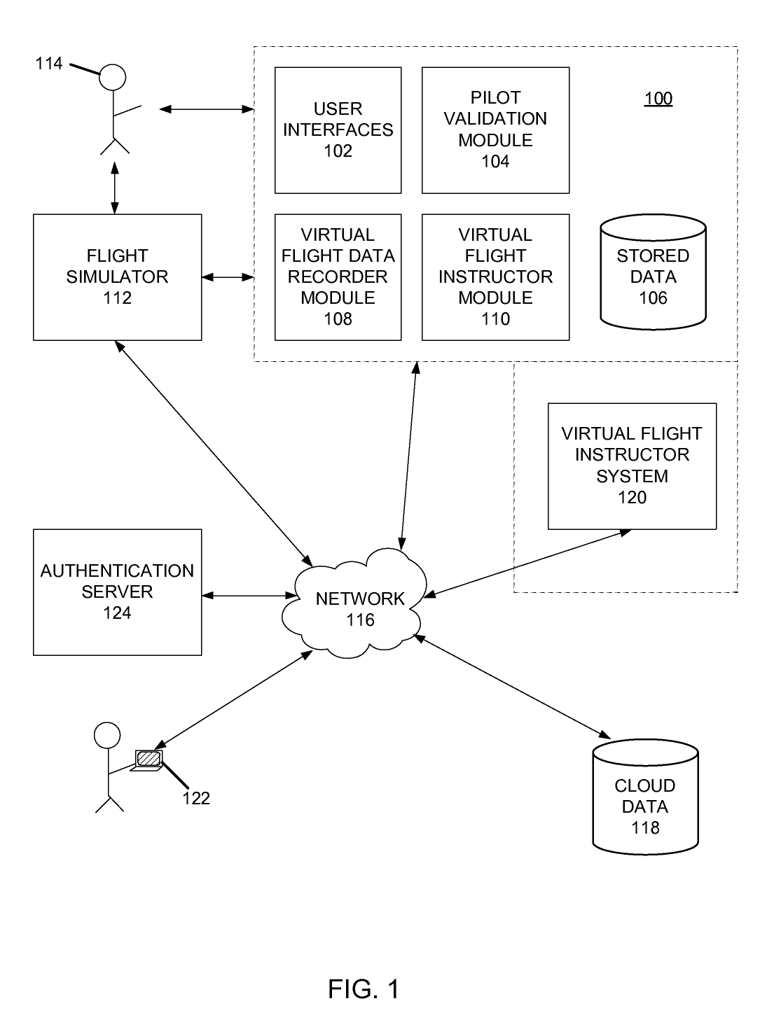

Referring to FIG. 1, an embodiment of an automated flight instruction system 100 for use with a flight simulator 112 is presented. The term “flight simulator 112” is intended to broadly cover flight simulators, flight trainers, and any other suitable equipment for obtaining flight experience used to log flight hours for flight training purposes, to gain aeronautical experience, and/or to maintain recency of flight experience for pilots 114. In various embodiments, the flight simulator 112 can be an FAA-approved Aviation Training Device (ATD), a Flight Training Device (FTD), and/or a Full Flight Simulator (FFS). The flight simulator 112 can also be equipment certified for use by other international aviation or governmental bodies. Aeronautical experience is intended to cover flight experience in general.

The automated flight instruction system 100 can include a user interface module 102, a pilot validation module 104, a Virtual Flight Data Recorder (VFDR 108) module, a Virtual Flight Instructor Module (VFIM 110), a data store 106, and a Virtual Flight Instructor System (VFIS 120). In a configuration, the automated flight instruction system 100 can be a PC, Mac or Linux based computer, such as a desktop computer, laptop, tablet, server, or similar computing device. In embodiments, one or more of the software modules 102, 104, 108, and 110 can execute in the flight simulator 112. The operations performed by each software module 102, 104, 108, and 110 can be performed by a common server or servers, or executed across multiple servers as would be understood in the art. In embodiments, the software modules 102, 104, 108, and 110 can include third-party software.

The user interface module 102 can be a web-based application or a stand-alone executable as appropriate for the automated flight instruction system 100 and the flight simulator 112. For example, a user such as a pilot 114 can use a web-browser such as Safari™, Opera™, Google™ Chrome™, Internet Explorer™, or the like to access the user interface module 102 of the automated flight instruction system 100. The automated flight instruction system 100, in accordance with the present disclosure, can be accessed via any appropriate and suitable technique.

If the pilot 114 has not previously used the automated flight instruction system 100, the pilot 114 can create an account with the automated flight instruction system 100. The pilot 114 provides information through a user interface module 102, for example through a web page on a website. To set up the account, the pilot 114 provides information to the pilot validation module 104. Suitable information can include personal information and information required by the Federal Aviation Administration (FAA). For example, in addition to selecting a user name and password for the account, the pilot 114 can be prompted to enter the pilot's name as it appears on the pilot's FAA pilot certificate, the pilot certification number, and the pilot's address registered with the FAA, among other suitable information. The pilot 114 can provide an email address and a cell phone number. The email address can be used to send confirmation of the flight results after the pilot 114 uses the automated flight instruction system 100. The email address can also be used to send reminders to the pilot 114 when the pilot's recency of flight experience is within a pre-defined time of expiration. The pilot 114 can set the pre-defined time of expiration or allow the automated flight instruction system 100 to use a default pre-defined time of expiration, for example one month. Similarly, text messages can be sent to a cell phone of the pilot 114 to provide status and send reminders.

The user interface 102 associated with the pilot validation module 104 prompts the pilot 104 to upload electronic images of documents required by the FAA to verify the pilot's identity. For example, pictures or electronic images of the FAA pilot certificate, the pilot's driver license or other FAA-acceptable forms of identification, an FAA flight medical document, and a photo of the pilot 114. The submitted photo of the pilot 114 can be a contemporaneous photo of the pilot 114 taken by the automated flight instruction system 100 at the time the pilot 114 uses the automated flight instruction system 100. The flight simulator 112 can include a camera for taking one or more photos of the pilot 114 during the training or testing, or a webcam of a laptop or camera of a smartphone can be used to take the photo of the pilot 114. The pilot 114 can provide an electronic signature to confirm that the information submitted is accurate.

The pilot validation module 104 can authenticate the pilot 114. For example, the pilot's driver license can be compared with the submitted photo of the pilot 114 for biometric confirmation of the pilot's identity. In an embodiment, some or all of the information provided by the pilot 114 can be sent to an authentication server 124, or compared with information accessible on an authentication server 124. An example authentication server 124 is the FAA airman database. One or more other authentication servers 124 can be used, for example those associated with state license bureaus, or federal departments such as the U.S. Department of Homeland Security. In an embodiment, the pilot 114 may be granted access to the automated flight instruction system 100 only if the authentication of the pilot's information is successful. In another embodiment, the information provided by the pilot 114 can be verified by a flight instructor 122, such as an FAA certified flight instructor (CFI). In this embodiment, the authentication can be performed when the flight instructor 122 is reviewing the forensic record of the flight by the pilot 114. The flight instructor 122 can contact the pilot 114 using email or the pilot's cell phone to resolve any issues. Other suitable authentication means, including authentication using electronic devices is also contemplated.

If the pilot 114 has already registered and set up an account on the automated flight instruction system 100, then the pilot 114 can be required to submit only a subset of the information required during registration. For example, the pilot 114 can be required to submit a new photo and a new signature, but the pilot only has to submit electronic copies of any updated documents, or certify that the previously presented information in the account of the pilot 114 is up to date.

The pilot 114 can download and install software associated with the Virtual Flight Data Recorder (VFDR 108) and a Virtual Flight Instructor Module (VFIM 110). For example, once the pilot 114 has an account on the automated flight instruction system 100, the pilot 114 can access a website to download the VFDR 108 and VFIM 110. The VFDR 108 and VFIM 110 can be stored on the data store 106. The data store 106 can be any suitable electronic medium, such as thumb drive (for executing a portable version of the VFDR 108 and VFIM 110), a laptop, a tablet, a home computer, and so forth. In an embodiment (not shown), the VFDR 108 and VFIM 110 are downloaded directly onto the flight simulator 112. In a configuration, the VFDR 108 and the VFIM 110 have been previously downloaded.

The pilot 114 can acquire an electronic flight syllabus, flight task list, and/or an aircraft configuration profile for the VFIM 110. The electronic flight syllabus, flight task list, and aircraft configuration profile can provide the pilot 114 with a geographic starting point and aircraft configuration. For example, the aircraft can be in flight, at a specific airspeed, altitude, power settings and other configurations necessary to comply with the training or testing requirements.

The VFDR 108 can record the flight of the virtual aircraft by the pilot 114. In a configuration, the pilot 114 can open a user interface 102 to the VFDR 108 in order to ensure proper recording of flight data. Flight data can include geographic position of the virtual aircraft as well as instrument outputs such as airspeed, direction, and altitude. Flight data can also include outputs from instruments and other suitable data as described in more detail below. The pilot 114 can be prompted to sign in to their user account. The pilot 114 can be prompted to commence streaming of data from the VFDR 108 to the Virtual Flight Instructor System (VFIS 120). The streaming of data can be performed over the Internet 116 and can be encrypted or otherwise made secure. The pilot 114 can be prompted to take a photo. As described above, the photo can be taken by the automated flight instruction system 100, or the flight simulator 112. The photo can be time-stamped. In a configuration, the pilot 114 can take a time-stamped photo using, for example, a smartphone and submitted as part of the verification that the pilot 114 performed the training or testing on the flight simulator 112. The pilot 114 also can take screen captures, or screenshots, of the flight simulator 112 via the user interfaces 102 presented by the VFDR 108 to provide verification that the limitations and contingencies of the flight simulator 112 are met. For some flight simulators 112, a compliance screen can appear when the flight simulator 112 is booted up or started. The pilot 114 can upload a photo or screenshot of the compliance screen of the flight simulator 112 to show that the flight simulator 112 used by the pilot 114 was in compliance with applicable regulations. For other flight simulators 112, the pilot can take pictures of FAA documentation associated with the flight simulator 112, or obtain electronic copies of the FAA documentation for the flight simulator 112.

The pilot 114 can start the flight simulator 112 and begin flying a flight syllabus and performing flight tasks. When the pilot 114 uses the flight simulator 112, the VFDR 108 can record a complete forensic record of the flight of the pilot 114 on the flight simulator 112. The forensic record can include the geographic position of the virtual aircraft and instrument outputs, including but not limited to, airspeed, heading or direction, altitude, vertical speed, and any navigation instrument displays including global positioning system (GPS), automatic direction finder (ADF), VHF omni directional radio range (VOR) receiver, instrument landing system (ILS) receiver, and so forth. The VFDR 108 can also record actions taken by the pilot 114. The forensic record can be stored on the data store 106.

Once the pilot is in the process of flying the defined flight syllabus, and performing the flight task list for the given aircraft configuration profile, the pilot 114 can receive real-time virtual guidance by the Virtual Flight Instruction Module (VFIM 110). The VFIM 110 can provide visual and/or audible warnings to pilots 114 flying outside of the set flight parameters or provide positive feedback. For example, the VFIM 110 can provide configurable warnings such as, “watch altitude”, “watch heading”, “low on glide slope”, and so forth, or feedback such as “good work”, or “task completed successfully”, and so forth. The VFIM 110 can use the defined parameters of the flight syllabus and flight task list to interact with the flight simulator 112 and provide real-time feedback regarding the performance of the pilot 114 within defined tolerances and parameters of flight such as altitude and geographic location.

Depending on the network connectivity and selected preferences, the VFDR 108 can stream data in real-time to the VFIS 120, and a flight instructor 122 can optionally view the data and the performance of the pilot 114 in real-time. A copy of the forensic record also can be stored in a cloud server 118, and viewed by a flight instructor 122 after the fact. Upon the completion of the flight, the VFDR 108 can save a copy of the forensic record, or a portion of the forensic record, to a removable media device of the pilot 114, such as a thumb drive, for the pilot's records. In a configuration, the forensic record recorded by the VFDR 108 can be submitted to the VFIS 120 at a future time. In a first example, if the forensic record was not streamed in real-time to the VFIS 120, then the forensic record can be sent to the VFIS 120 upon completion of the flight, when Internet connectivity is available, or when requested (polled) by the VFIS. 120. In another example, the pilot 114 can log into the pilot's account on the automated flight instruction system 100 and, through a user interface 102, upload the forensic record. For example, a web page can be presented to the pilot 114 that allows the pilot to sync, or synchronize, forensic records on a thumb drive with the VFIS 120. Example data that can be uploaded can include the electronic record of the flight of the pilot 114, a screen shot showing that the limitations and contingencies of the flight simulator 112 were met, a letter of authorization (LOA) for the flight simulator 112, and a time-stamped photo of the pilot 114 taken prior to or during operation of the flight simulator 112. In a configuration, the pilot 114 can manually upload documents and indicate or select the make and model of the flight simulator 112, the date and exact flight tasks that were completed, and certification by the pilot 114 that the pilot 114 personally completed the flight tasks of the flight syllabus.

The VFIS 120 can review and verify the forensic record and any other files to ensure that the pilot 114 flew the assigned flight syllabus and performed the flight tasks within the defined parameters. The forensic record provides an exact record of the content and duration of the flight and can be used by the VFIS 120 to log credit toward the pilot's recency of flight experience for instrument flight certification, to capture aeronautical experience of the pilot 114, and/or provide a record of flight training. The file associated with a flight of a pilot 114 can be received by the VFIS 120 either automatically via the VFDR 108 or via manual upload from the web-based account of the pilot 114. The VFIS 120 can review the file to confirm that it is a distinct file and does not represent a copy of an earlier submission. The VFIS 120 can conduct an automated VFDR flight electronic record review to confirm that the flight was flown within defined flight parameters which can include reviewing the outputs of flight simulator 112 such as an Aviation Training Device (ATD), Flight Training Device (FTD), or Full Flight Simulator (FFS). The outputs that are reviewed can include geographic position and instrument outputs such as airspeed, vertical speed, direction, altitude, and navigation instruments (i.e., GPS, ILS, VOR receiver, ADF, etc.) The file can be scored based on the assigned flight syllabus and flight tasks, and can include measuring accuracy of parameters such as maintaining assigned altitude, airspeed, navigation, tracking of navigation instruments, stability, and maintaining a holding pattern. The VFIS 120 can produce one or more summary reports. For example, the VFIS 120 can produce separate summary reports, one for the pilot 114 and one for a flight instructor 122. The summary can include an analysis and score of the pilot's flight performance and provide recency of flight experience certification for the pilot. The VFIS 120 can send the file to cloud storage 118 for official record keeping. As is to be readily appreciated, the particular metrics, scoring system, rules, reports, and so forth are merely intended to be illustrative and not limiting.

The VFIS 120 can provide a record of certification of the results to the pilot 114. The VFIS 120 can send the pilot 114 a record of the accomplished flight tasks along with the date of the submission of the data from the VFDR 108 to the VFIS 120. The flight instructor 122 can verify that the pilot 114 flew within the defined flight parameters of the flight syllabus and performed the flight tasks. The flight instructor 122 can be an FAA certified flight instructor (CFI). The flight instructor 122 can provide a written record to the pilot that verifies the time and content of the flight session for insertion into a logbook of the pilot 114. The pilot 114 can place the written record into the logbook in order to be in compliance with FAA documentation requirements.

The VFIS 120 can remind pilots 114 of the recency of their flight experience requirements. The VFIS can send an email to the pilot 114 or send a text to a cell phone within a configurable or pre-defined period of time of expiration. For example, the VFIS 120 can send a reminder two months prior to the time of expiration. The email can include an embedded link. The embedded link can direct the pilot 114 to their account, or provide the latest monthly maneuvers or an electronic syllabus for the pilot 114 to complete.

The example embodiments allow pilots 114 to log recency of flight experience and simulator time without requiring that an FAA certified flight instructor (CFI) 122 be present. For example, a pilot in rural Iowa could fly a specific flight syllabus of instrument flight tasks on an FAA-approved Full Flight Simulator (FFS), Flight Training Device (FTD), or Aviation Training Device (ATD) at times when it would otherwise be impossible or impractical due to scheduling or other travel issues for the pilot 114 and flight instructor 122 to be present at the same time for the entire duration at the location of the FFS, FTD, or ATD. The automated flight instruction system 100 provides more access to flight training options and increased convenience for pilots 114. Additionally, the forensic record permits detailed review of the pilot's performance after the flight simulation, allowing the pilot 114 and/or flight instructor 122 to focus on weak areas of performance, such as where the pilot 114 flew outside the acceptable flight parameters, which can result in increased flight proficiency by the pilot 114. The VFIM 110 can provide a playback video from the flight data to assist in post-flight review by the pilot 114 and flight instructor 122.

The automated scoring system of the VFIS 120 can assist the flight instructor 122 in reviewing the performance of the pilot 114, and allow the flight instructor 122 to more quickly and economically provide proper credit to pilots 114 for tasks completed, for example by not requiring the flight instructor 122 to review the entire flight simulation. The automated scoring system of the VFIS 120 can assist pilots 114 by providing an unbiased, impartial evaluation of the performance of the flight tasks of the flight syllabus by the pilot 114. The automated scoring system of the VFIS 120 can assist pilots 114 by providing independent real-time evaluation of the performance, which not only can catch errors missed by a flight instructor 122, but also allows the pilot 114 to receive immediate corrective guidance during the flight simulation.

The automated flight instruction system 100 can communicate with the flight simulator 112, authentication server 124, virtual flight instructor system 120, and access data in the cloud server 118 using any suitable communication channels and protocols. For example, the Internet 116, as shown, can be the communication network. In another example, the automated flight instruction system 100 can use a wired connection to a local network, or use a wireless WiFi/802.11x local network. Other suitable communication channels and protocols can include, without limitation, those used in mobile wireless communications as well as data links for wired and wireless networked connections. In a configuration, the automated flight instruction system 100 can use a data link over the Internet 116 to connect to other systems, for example using a FTP or file transfer protocol session, secure sockets, a VPN or virtual private network connection, and so forth.

Each software module 102, 104, 108, and 110 can include software or other computer instructions executing on suitable computing hardware, such as a dedicated server, a personal computer, a server, multiple computers, a collection of networked computers, a cloud-based computer system, a web-based computer system, or from a storage device, as appropriate for automated flight instruction system 100 and the flight simulator 112. Each computing device can include one or multiple processing units, such as central processing units and/or graphics processing units, may perform instructions stored in memory to execute the processes described herein.

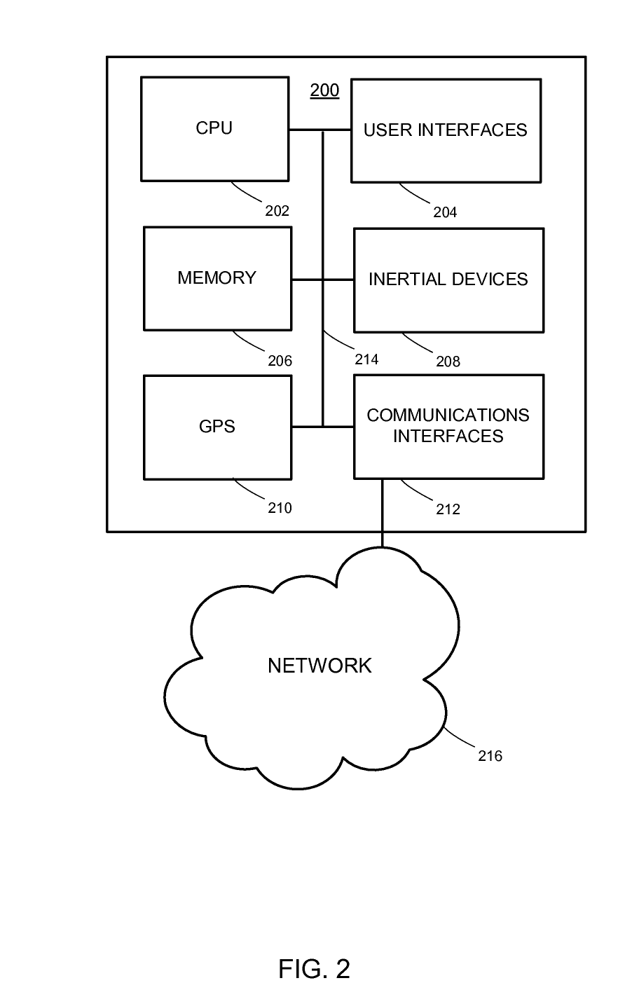

Referring now to FIG. 2, an example computing device 200 is presented. The processes described herein can be performed on or between one or more computing devices 200. A computing device 200 can be a server, a computing device that is integrated with other systems or subsystems, a mobile computing device, a cloud-based computing capability, and so forth. For example, the computing device 200 depicted in FIG. 2 can be the automated flight instruction system 100 or a processor-based device that executes one or more of the software modules 102, 104, 108, 110, the virtual flight instructor system 120, a personal computing device of the flight instructor 122, the authentication server 124, and so forth. The computing device 200 can be any suitable computing device as would be understood in the art, including without limitation, a custom chip, an embedded processing device, a tablet computing device, a personal data assistant (PDA), a desktop, a laptop, a microcomputer, a minicomputer, a server, a mainframe, or any other suitable programmable device. In various embodiments disclosed herein, a single component can be replaced by multiple components and multiple components can be replaced by a single component to perform a given function or functions. Except where such substitution would not be operative, such substitution is within the intended scope of the embodiments.

Each computing device 200 includes one or more processors 202 that can be any suitable type of processing unit, for example a general purpose central processing unit (CPU), a reduced instruction set computer (RISC), a processor that has a pipeline or multiple processing capability including having multiple cores, a complex instruction set computer (CISC), a digital signal processor (DSP), an application specific integrated circuits (ASIC), a programmable logic devices (PLD), and a field programmable gate array (FPGA), among others. The computing resources can also include distributed computing devices, cloud computing resources, and virtual computing resources in general.

The computing device 200 also includes one or more memories 206, for example read only memory (ROM), random access memory (RAM), cache memory associated with the processor 202, or other memories such as dynamic RAM (DRAM), static ram (SRAM), programmable ROM (PROM), electrically erasable PROM (EEPROM), flash memory, a removable memory card or disk, a solid state drive, and so forth. The computing device 200 also includes storage media such as a storage device that can be configured to have multiple modules, such as magnetic disk drives, floppy drives, tape drives, hard drives, optical drives and media, magneto-optical drives and media, compact disk drives, Compact Disk Read Only Memory (CD-ROM), Compact Disk Recordable (CD-R), Compact Disk Rewriteable (CD-RW), a suitable type of Digital Versatile Disk (DVD) or BluRay™ disk, and so forth. Storage media such as flash drives, solid state hard drives, redundant array of individual disks (RAID), virtual drives, networked drives and other memory means including storage media on the processor 202, or memories 206 are also contemplated as storage devices. It can be appreciated that such memory can be internal or external with respect to operation of the disclosed embodiments. It can be appreciated that certain portions of the processes described herein can be performed using instructions stored on a computer-readable medium or media that direct a computer system to perform the process steps. Non-transitory computer-readable media, as used herein, comprises all computer-readable media except for transitory, propagating signals.

Network and communication interfaces 212 can be configured to transmit to, or receive data from, other computing devices 200 across a network 216. The network and communication interfaces 212 can be an Ethernet interface, a radio interface, a Universal Serial Bus (USB) interface, or any other suitable communications interface and can include receivers, transmitter, and transceivers. For purposes of clarity, a transceiver can be referred to as a receiver or a transmitter when referring to only the input or only the output functionality of the transceiver. Example communication interfaces 212 can include wired data transmission links such as Ethernet and TCP/IP. The communication interfaces 212 can include wireless protocols for interfacing with private or public networks 216. For example, the network and communication interfaces 212 and protocols can include interfaces for communicating with private wireless networks 216 such as a WiFi network, one of the IEEE 802.11x family of networks, or another suitable wireless network. The network and communication interfaces 212 can include interfaces and protocols for communicating with public wireless networks 216, using for example wireless protocols used by cellular network providers, including Code Division Multiple Access (CDMA) and Global System for Mobile Communications (GSM). A computing device 200 can use network and communication interfaces 212 to communicate with hardware modules such as a database or data store, or one or more servers or other networked computing resources. Data can be encrypted or protected from unauthorized access, for example by using secure sockets, virtual private networks, and so forth.

Mobile computing devices can include inertial components 208 and global positioning systems components (GPS components 210). The inertial components 208 and GPS components 210 can determine the terrestrial position of the mobile computing devices. Mobile computing devices can use the inertial components 208 and GPS components 210 in combination with radio transmissions received via the network and communication interfaces 212 to accurately determine the position of a mobile computing device. The position information can be included in data associated with a photo to indicate where the photo was taken and provide a timestamp for when the photo was taken.

In various configurations, the computing device 200 can include a system bus 214 for interconnecting the various components of the computing device 200, or the computing device 200 can be integrated into one or more chips such as programmable logic device or application specific integrated circuit (ASIC). The system bus 214 can include a memory controller, a local bus, or a peripheral bus for supporting input and output devices 204, and communication interfaces 212. Example input and output devices 204 include keyboards, keypads, gesture or graphical input devices, motion input devices, touchscreen interfaces, one or more displays, audio units, voice recognition units, vibratory devices, computer mice, and any other suitable user interface.

The processor 202 and memory 206 can include nonvolatile memory for storing computer-readable instructions, data, data structures, program modules, code, microcode, and other software components for storing the computer-readable instructions in non-transitory computer-readable mediums in connection with the other hardware components for carrying out the methodologies described herein. Software components can include source code, compiled code, interpreted code, executable code, static code, dynamic code, encrypted code, or any other suitable type of code or computer instructions implemented using any suitable high-level, low-level, object-oriented, visual, compiled, or interpreted programming language.

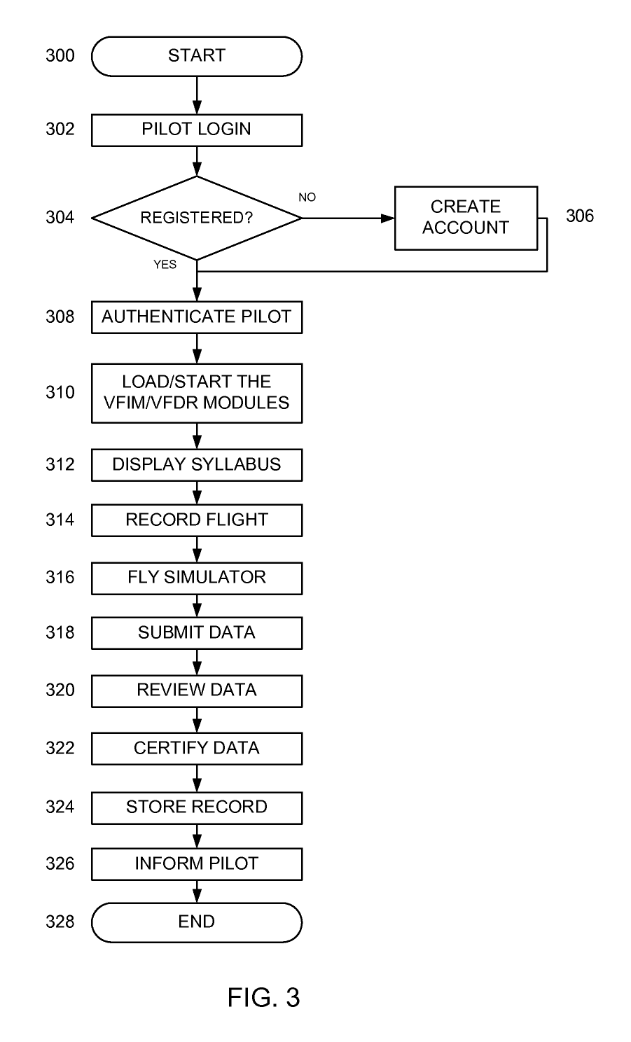

Referring now to FIG. 3, an example flow diagram of an automated flight instruction system 100 is presented. The operations of the automated flight instruction system 100 can provide authentication of the identity of the pilot, produce a forensic record of the flight, validate the fight simulator equipment as complying with FAA requirements, provide an automated review of the pilot's simulated flight and performance of the flight tasks of a flight syllabus, and permit certification of the time and content of the flight that can be used to fulfill the recency of experience logging for instrument-rated pilots, logging of aeronautical experience, and/or training for both instrument-rated pilots and non-instrument-rated pilots 114. Processing starts at start block 300 and continues to process block 302.

In process block 302, the pilot can attempt to log into the automated flight instruction system 100 as described above. For example, a pilot can use a web browser to access a web page that requests login information. The pilot can provide a user name and password to log in to the automated flight instruction system 100. Processing continues to decision block 304.

In decision block 304, if the pilot is a registered user, processing continues to process block 308. Otherwise processing continues to process bock 306 to create an account for the pilot.

In process block 306, the pilot creates an account as described above. For example, the pilot can select a user name and password, enter personal information such as an email address and mailing address, and upload required copies of documents, such as the pilot's driver license, and FAA required documents such as the pilot's FAA pilot certificate, pilot certification number, and FAA medical certificate. Processing continues to process block 308.

In process block 308, the pilot optionally can be authenticated. The automated flight instruction system 100 can require the pilot to upload a photo as described above. The photo can be compared with the pilot's driver license or a previously submitted photo. In a configuration, the pilot is authenticated by an FAA certified flight instructor when the pilot's flight data is certified in process block 322. Processing continues to process block 310.

In process block 310, the VFDR module and the VFIM modules can be loaded and executed. For example, the VFDR and VFIM modules can be downloaded across the Internet from the VFIS. In a configuration, the VFDR and VFIM modules are already loaded, for example on a pilot's thumb drive or on the flight simulator, and are executed on the appropriate computing device. Processing continues to process block 312.

In process block 312, a flight syllabus is loaded into the VFIM and displayed to the pilot. For example, if the pilot received notification by email that a particular flight syllabus was available to the pilot, the email could have a link to the flight syllabus which could be downloaded into the VFIM. The flight syllabus includes flight tasks for the pilot to perform on the flight simulator. Processing continues to process block 314.

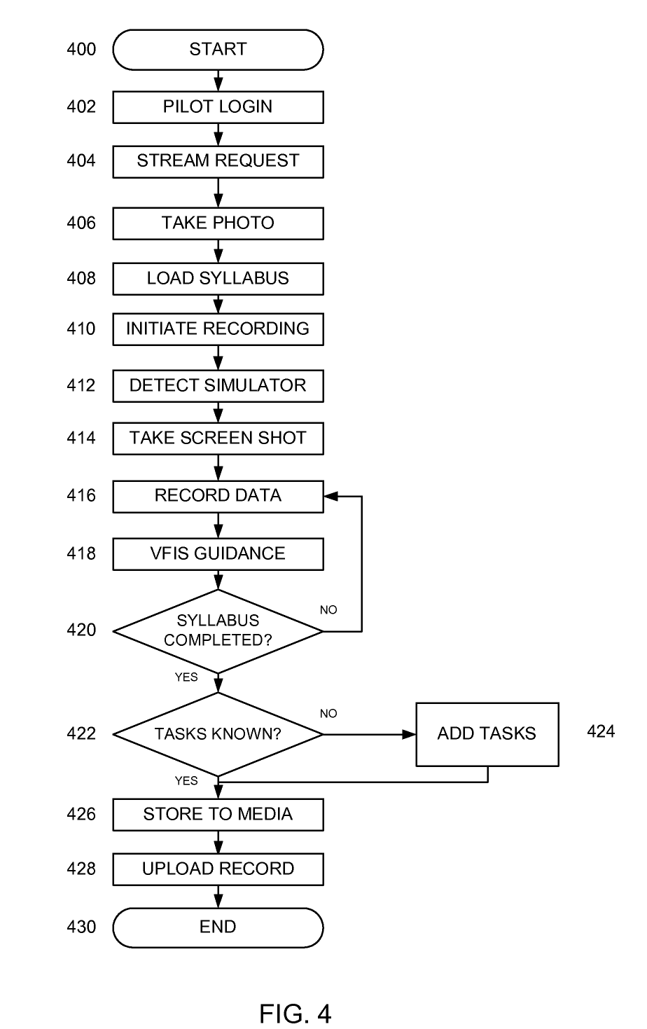

In process block 314, the VFDR records data from the flight simulator to create a forensic record of the flight as described above, and below with regard to FIG. 4. Processing continues to process block 316.

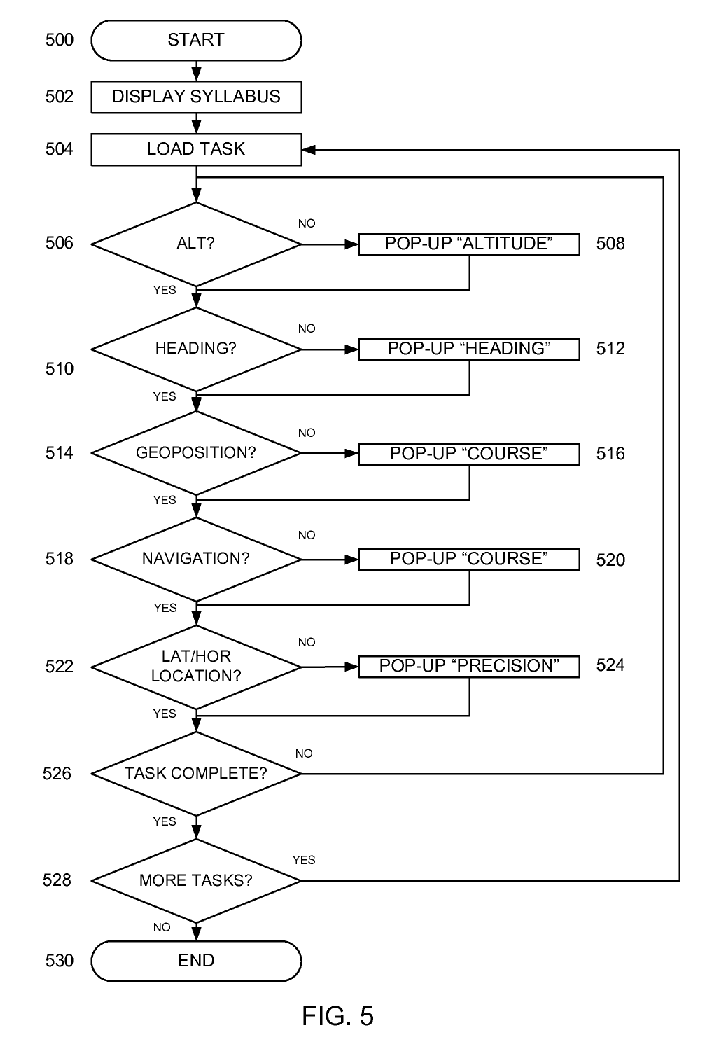

In process block 316, the pilot performs the flight tasks of the flight syllabus on the flight simulator. The pilot can receive instruction and feedback from the VFIM as described with regard to FIG. 5 below. The VFIM can add data to the forensic record. Once the pilot performs the tasks in the flight syllabus, processing continues to process block 318.

In process block 318, the forensic record is submitted to the VFIS. The forensic record can be automatically submitted by the VFDR, or uploaded by the pilot. The forensic record can include other data in addition to flight data, such as the photo of the pilot, a screenshot or photo of a compliance screen of the flight simulator, and certification information such as an FAA letter of authorization (LOA) for the flight simulator. In a configuration, the pilot can provide identification of the flight simulator separately. Processing continues to process block 320.

In process block 320, the data submitted in process block 318 can be reviewed by the VFIS. The flight data can be quantitatively compared against expected flight data for the fight tasks and flight syllabus. The VFIS can optionally produce a score for the flight and one or more summaries can be generated. Processing continues to process block 322.

In process block 322, an FAA certified flight instructor (CFI) can certify the pilot's activity on the flight simulator. The CFI can examine the forensic record and the automated scoring and summary if produced by the VFIS in process block 320. The CFI can authenticate the pilot by biometrically comparing the photo with the pilot's driver license or other information associated with the pilot's account. The CFI can contact the pilot to resolve any discrepancies. Processing continues to process block 324.

In process block 324, a certified record of the pilot's activity on the flight simulator can be stored and archived, for example in a cloud server. Processing continues to process block 326.

In process block 326, a written record of the pilot's activity on the flight simulator can be sent to the pilot and placed into the pilot's logbook to comply with FAA documentation requirements. The pilot can be informed of the recency of the pilot's flight experience requirements through periodic emails and other messages.

Referring now to FIG. 4, an example flow diagram of a virtual flight data recorder 108 is presented. The operations of the virtual flight data recorder 108 can produce a forensic record of the flight, which can be stored and linked to the pilot's flight certificate, and which can include a time-stamped photo of the pilot, a copy of the FAA-issued Letter of Authorization (LOA) for the flight simulator, and a screenshot of the flight simulator opening screen to show that the flight simulator is in compliance with FAA standards. Processing starts at start block 400 and continues to process block 402.

In processing block 402, a user, such as a pilot, logs into their account on the automated flight instruction system 100. Processing continues to process block 404.

In process block 404, the pilot is prompted for permission to stream data to the VFIS in real time. In a configuration, the pilot can receive a copy of the forensic record and other data that can be uploaded to the VFIS after the flight simulation. Processing continues to process block 406.

In process block 406, a photo of the pilot is taken and the pilot is requested to upload an image of the LOA for the flight simulator as described above. The pilot is prompted to verify the photo and the image of the LOA for the flight simulator. The photo and image of the LOA for the flight simulator are added to the forensic record. Processing continues to process block 408.

In process block 408, a flight syllabus to be performed by the pilot on the flight simulator is loaded into the VFIM. The flight syllabus can be downloaded from the VFIS if there network connectivity, such as a connection over the Internet. Alternatively, the syllabus can be loaded from media, such as a thumb drive of the pilot, or from electronic storage associated with the flight simulator. The flight syllabus can include a monitoring syllabus for the VFIM, such as a set of instructions for the VFIM to provide guidance to the pilot during the operation of the flight simulator. Processing continues to process block 410.

In process block 410, the VFDR can initiate recording of the flight data. The VFIM can begin executing. Processing continues to process block 412.

In process block 412, the VFDR monitors flight data from the flight simulator and detects when the flight simulator has initiated the simulation. Once the flight simulator has initiated the simulation, the pilot can start performing the flight tasks associated with the flight syllabus. Processing continues to process block 414.

In process block 414, the VFDR takes a screen shot of the opening compliance screen of the flight simulator. The screen shot can be added to the forensic record. Processing continues to process block 416.

In process block 416, the VFDR captures the flight data while the pilot performs the flight tasks associated with the flight syllabus. The VFDR can stream the flight data in real time to the VFIS, permitting a flight instructor, such as a CFI, to monitor and review the pilot's performance in real-time. The flight data can be used to recreate the flight for a post-flight review by a flight instructor or the pilot. The VFDR can optionally capture pictures of the pilot and/or video of the flight and add the pictures or video to the forensic record. Processing continues to process block 418.

In process block 418, while the pilot performs the flight tasks associated with the flight syllabus, the VFIM can provide guidance and instruction to the pilot. Example operations associated with process block 418 are described in greater detail with regard to FIG. 5 below. Processing continues to decision block 420.

In decision block 420, if the VFDR or VFIM detects that the flight tasks and flight syllabus have been completed by the pilot, or if the pilot terminates the flight simulation/training then processing continues to decision block 422, otherwise, processing continues back to process block 416 to continue recording the flight data.

In decision block 422, if the flight syllabus and flight tasks were loaded in process block 408 and detected as completed by the VFDR or VFIM, then processing continues to process block 426. Otherwise, processing continues to process block 424.

In process block 424, the pilot can enter the flight tasks and/or the portion of the flight syllabus performed by the pilot. The information can be stored in the forensic record. Processing continues to process block 426.

In process block 426, the forensic record can be stored to media. For example, the forensic record can be stored as a file on local media, for example a data store or hard drive associated with a computing device. The forensic record can optionally be stored to a thumb drive of the pilot or other suitable media. Processing continues to process block 428.

In process block 428, the forensic record can be uploaded to the VFIS or onto a cloud based server. The VFDR can automatically upload the forensic record to the VFIS. Optionally, the pilot can upload the forensic record from the pilot's thumb drive or other media. Processing terminates at end block 430.

Referring now to FIG. 5, an example flow diagram of a virtual flight instructor module (VFIM) 110 is presented. The virtual flight instructor module 110 can be enabled by pre-defined flight parameters such as flight path, and altitude, and acceptable limits of instrument outputs that can be stored in the flight syllabus. The virtual flight instructor module 110 can determine if the pilot is performing the flight tasks on the flight simulator within the acceptable parameters or limits and provide real-time feedback and instruction to the pilot during performance of the flight tasks of the flight syllabus. Processing starts at start block 500 and continues to process block 502.

In process block 502, the flight syllabus is presented to the pilot. The flight syllabus includes one or more flight tasks, such as flying along a particular route, maintaining a holding pattern, performing a landing, executing an instrument approach, and so forth. The virtual flight data recorder (VFDR) can begin recording as described above, and continue to record until all of the flight tasks are determined to be complete in decision block 528. Generally, the objective is to record the entire flight so as to have a complete record of the pilot's flight. However, in alternative configurations, the VFDR can start or stop recording based on other criteria as would be understood in the art. For example, the VFDR can stop recording if the pilot's flight is terminated before all of the flight tasks of the flight syllabus are complete. In another example, the VFDR can start recording in process block 504 when the pilot begins a flight task and can stop recording after the flight task is determined to be complete in decision block 526, which can allow individual flight tasks to be recorded separately. Processing continues to process block 504.

In process block 504, a flight task of the flight syllabus is loaded into the VFIM and the pilot receives instruction to perform the flight task on the flight simulator 112. The VFIM monitors the outputs of the flight simulator 112 in real-time and compares the outputs to the required parameters in the flight syllabus and flight task. Processing continues to decision block 508.

In decision block 506, if the monitored altitude is not within allowable parameters, processing continues to process block 508. An example of an allowable parameter for the monitored altitude can be any altitude that exceeds plus or minus 80 feet from the flight path in the flight syllabus. If the monitored altitude is within the allowable parameters, then processing continues to decision block 510.

In process block 508, the VFIM can cause an indication to be provided to the pilot. For example, a pop-up reminder of “Altitude” can be provided, or a verbal statement can be provided. Additional information, such as a suggested course of action to correct the pilot error can be provided. The VFIM can record the error. Processing continues to decision block 510.

In decision block 510, if the monitored heading is not within allowable parameters, processing continues to process block 512. An example of an allowable parameter for the monitored heading can be any heading that deviates more than plus or minus 10 degrees from the flight path in the flight syllabus. If the monitored heading is within the allowable parameters, then processing continues to decision block 514.

In process block 512, the VFIM can cause an indication to be provided to the pilot. For example, a pop-up reminder of “Heading” can be provided, or a verbal statement can be provided. Additional information, such as a suggested course of action to correct the pilot error can be provided. The VFIM can record the error. Processing continues to decision block 514.

In decision block 514, if the monitored geoposition of the virtual aircraft is not within allowable parameters, processing continues to process block 516. An example of an allowable parameter for the monitored geoposition can be any position that deviates more than a configurable distance from the flight path in the flight syllabus. If the monitored geoposition is within the allowable parameters, then processing continues to decision block 518.

In process block 516, the VFIM can cause an indication to be provided to the pilot. For example, a pop-up reminder of “Course” can be provided, or a verbal statement can be provided. Additional information, such as a suggested course of action to correct the pilot error can be provided. The VFIM can record the error. Processing continues to decision block 518.

In decision block 518, if the monitored navigation instrument outputs from the flight simulator exceed assigned limits, processing continues to process block 520. An example of assigned limits can be any navigation instrument output that indicates an unexpected range given the flight task or an unsafe or atypical flight for the virtual aircraft. If the monitored navigation instrument outputs are within the assigned limits, then processing continues to decision block 522.

In process block 520, the VFIM can cause an indication to be provided to the pilot. For example, a pop-up reminder of “Course” can be provided, or a verbal statement can be provided. Additional information, such as a suggested course of action to correct the pilot error can be provided. The VFIM can record the error. Processing continues to decision block 522.

In decision block 522, if the monitored lateral or horizontal location of the virtual aircraft exceeds assigned limits, processing continues to process block 524. An example of assigned limits can be any lateral or horizontal location that indicates a general lack of precision in controlling the flight of the virtual aircraft given the flight task. If the monitored lateral and horizontal location are within the assigned limits, then processing continues to decision block 526.

In process block 524, the VFIM can cause an indication to be provided to the pilot. For example, a pop-up reminder of “Precision” can be provided, or a verbal statement can be provided. Additional information, such as a suggested course of action to correct the pilot error can be provided. The VFIM can record the error. Processing continues to decision block 526.

In decision block 526, if the pilot has completed the flight task, then processing continues to decision block 528, otherwise monitoring continues at decision block 506.

In decision block 528, if there are more flight tasks to be performed in the flight syllabus, then processing continues back to 504 where a new flight task is loaded. Otherwise, if all of the tasks have been completed, the virtual flight data recorder (VFDR) stops recording and processing terminates at end block 530.

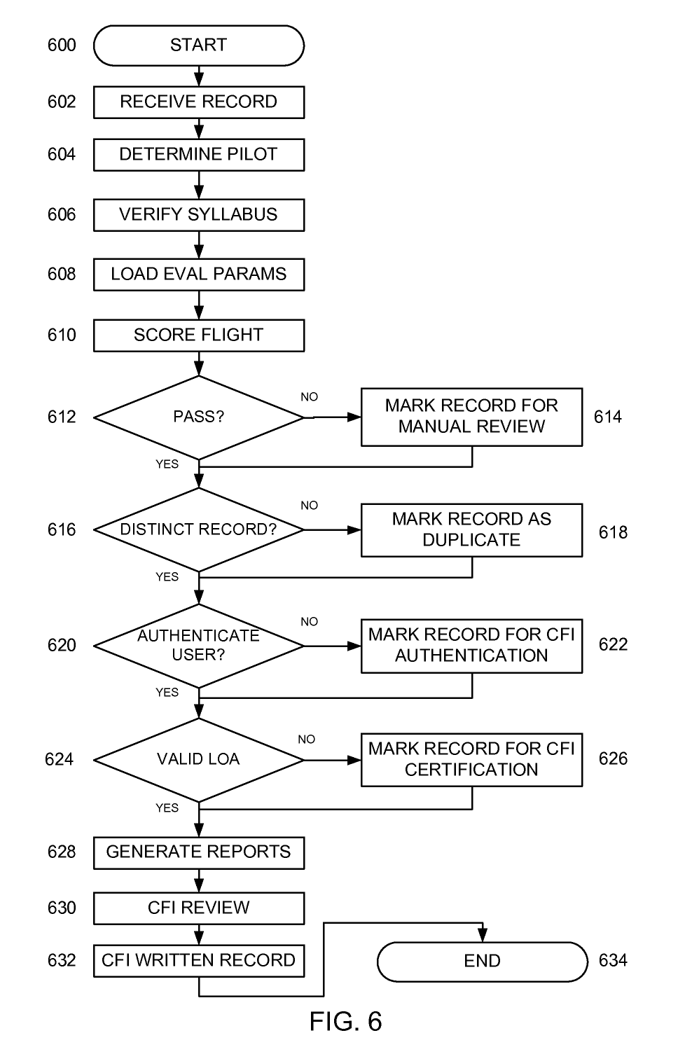

Referring now to FIG. 6, an example flow diagram of a virtual flight instructor system (VFIS) 120 is presented. The virtual flight instructor system 120 can confirm that the pilot performed the flight tasks of the flight syllabus within acceptable parameters, can analyze the performance of the pilot and provide performance scoring, can confirm that the submitted forensic record is not a duplicate record or replication of a previous recorded flight, authenticate the pilot as being biometrically identical to the pilot's government-issued identification, and validate the flight simulator as being in compliance with FAA standards. The virtual flight instructor system 120 can produce one or more reports including a pilot report regard completion of flight tasks of the flight syllabus. The pilot report can include one or more scores to allow the pilot to better evaluate the pilot's performance during execution of the flight tasks of the flight syllabus. Automated scoring can help to identify areas of strong or weak performance by the pilot. The virtual flight instructor system 120 can produce a flight instructor report that, in addition to providing the information above, can also include data from the VFIS analysis of the pilot's performance of the flight tasks of the flight syllabus that can identify areas where the pilot exceeded the acceptable flight parameters. Processing starts at start block 600 and continues to process block 602.

In process block 602, the VFIS receives the forensic record from the VFDR. The forensic record can be a structured block of data, a file, a set of files, a reference to data in a database, or any other suitable data. Processing continues to process block 604.

In process block 604, the VFIS determines the pilot identity from the forensic record. The VFIS can retrieve data from the pilot account of the automated flight instruction system. Processing continues to process block 606.

In process block 606, the VFIS can detect the flight syllabus and flight tasks performed by the pilot. The VFIS can request accurate flight syllabus and flight tasks numbers from the pilot, for example by email, if the detected flight syllabus and flight tasks do not match a known flight syllabus. Example flight tasks can include performing instrument landing system (ILS) approaches, tracking, and holding patterns, among other flight tasks. Processing continues to process block 608.

In process block 608, the VFIS can load the rules, scoring system, and other flight evaluation parameters for the flight syllabus and flight tasks performed by the pilot on the flight simulator. For example, if an Instrument Landing System (ILS) approach is the selected flight task, the rules, scoring system, and flight evaluation parameters can concentrate primarily, or exclusively, on specific instrument outputs such as airspeed, the course deviation indicator (CDI—horizontal) needles, and glide slope (GS—vertical). Other suitable rules, scoring systems, and flight evaluation parameters can be based upon the individual flight tasks being performed, as would be understood by one of ordinary skill in the art. Processing continues to process block 610.

In process block 610, the VFIS can detect completion of the flight syllabus and flight tasks from the forensic record. The VFIS can apply the rules, scoring system, and other flight evaluation parameters to the data in the forensic record to determine scoring of the individual flight tasks and the flight syllabus. Scores can be calculated by comparing the data in the forensic record for instrument outputs against optimal values for the tasks performed and determining the amount of deviation from the optimal values during the pilot's performance of the flight tasks. Processing continues to decision block 612.

In decision block 612, if the pilot has failed any of the tasks or the flight syllabus, processing continues to process block 614, otherwise processing continues to decision block 616.

In process block 614, the forensic record can be marked for manual review by a flight instructor, such as an FAA certified flight instructor (CFI). Processing continues to decision block 616.

In decision block 616, if the VFIS detects that the forensic record has already been submitted, for example by comparing the forensic record with previously submitted forensic records or by checking metadata in the forensic record, then processing continues to process block 618. Otherwise, processing continues to decision block 620.

In process block 618, the forensic record can be marked as duplicate record. The pilot does not receive credit for the duplicate submission. Processing continues to decision block 620.

In decision block 620, if the VFIS detects that the pilot who operated the flight simulator is not the pilot associated with the account, then processing continues to process block 622. Otherwise, processing continues to decision block 624.

In process block 622, the forensic record can be marked for further review and manual user authentication by a CFI. Processing continues to decision block 624.

In decision block 624, if the VFIS cannot confirm the validity of the FAA Letter of Authorization (LOA) associated with the flight simulator, or if the VFIS cannot confirm from the compliance screen whether the flight simulator is in compliance with FAA standards, then processing continues to process block 626. Otherwise, processing continues to process block 628.

In process block 626, the forensic record can be marked for further review by a CFI. The CFI can request the pilot to identify the type of flight simulator used for the flight simulation/training. The CFI can request that the pilot confirm that the flight simulator displayed a compliance screen stating that the flight simulator was in compliance with FAA standards. Processing continues to process block 628.

In process block 628, the VFIS can generate one or more reports as describe above. For example, the VFIS can generate a pilot report for the pilot that identifies any errors in the pilot's performance of the flight tasks and flight syllabus. The pilot report can include one or more scores. The pilot report and related data can be exported to the pilot's account. In another example, the VFIS can generate a flight instructor report for the CFI. The flight instructor report can identify errors in the pilot's performance of the flight tasks and flight syllabus, include one or more scores, and identify areas of the forensic report to be reviewed by the CFI. Processing continues to process block 630.

In process block 630, the CFI can review the forensic record and the flight instructor report. The CFI can communicate with the pilot to resolve any discrepancies and determine whether the pilot has successfully completed the flight tasks and flight syllabus. Processing continues to process block 632.

In process block 632, the CFI can provide a written record to the pilot that verifies the time and content of the flight session for insertion into a logbook of the pilot 114. The pilot 114 can place the written record into the logbook in order to be in compliance with FAA documentation requirements. Processing terminates at end block 634.

Generally, the operations described in process blocks and decision blocks 300 through 634 can be performed in any order, as would be understood by one of ordinary skill in the art.

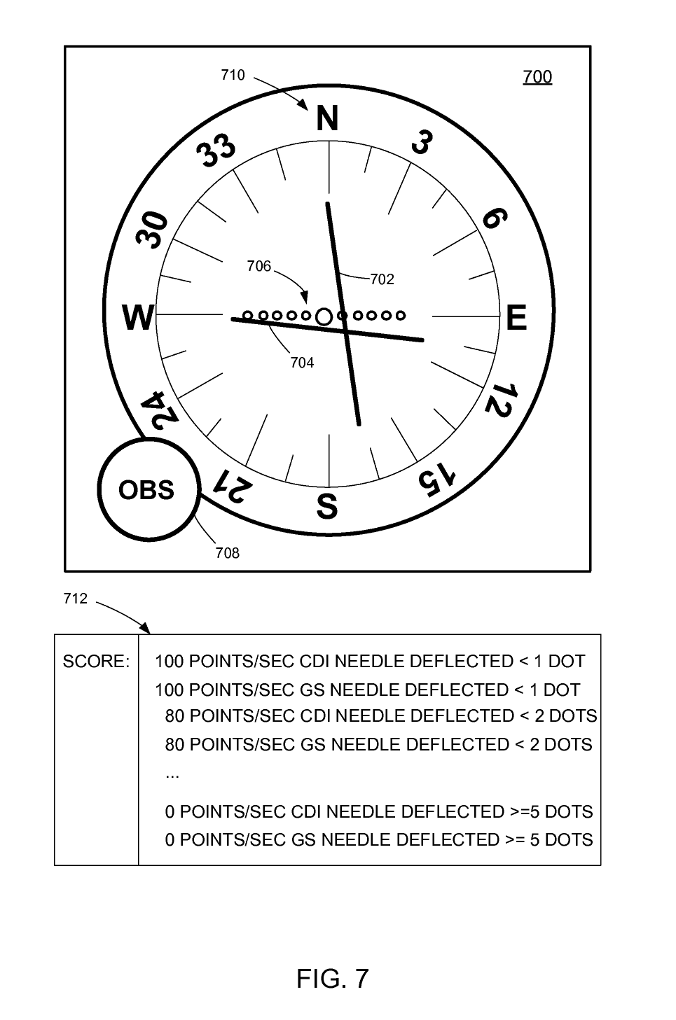

Referring now also to FIG. 7, an example scoring profile for the automated flight instruction system 100 is presented. FIG. 7 illustrates example instrument outputs and associated scoring 712 for an instrument landing system receiver, or ILS receiver 700, used during an ILS approach. The ILS receiver 700 includes navigation needles such as a horizontal guidance needle (CDI needle 702) and a vertical guidance needle (GS needle 704) for determining whether the pilot is flying within acceptable flight parameters during the instrument approach. The Course Deviation Indicator needle, or CDI needle 702, is used to measure whether the pilot flew within the defined lateral, or horizontal, flight parameters. The Glide Slope needle, or GS needle 704, is used to measure whether the pilot flew within the defined vertical flight parameters. A series of dots 706 provide a gauge to measure the deviation from the intended approach. Generally, each dot indicated two degrees of deviation from the intended approach. An Omni Bearing Selector, or OBS 708, can be turned to provide directional information to/from VOR (VHF Omni Directional Radio Range) guided approaches and is not used for approaches using the ILS receiver 700. The ILS receiver 700 can include a rotating course card 710 that indicated the compass direction the pilot is flying the simulated aircraft.

The VFIS 120 can score 712 the pilot's ILS approach, either in real-time, or after the simulated flight is complete from the forensic record. An example scoring system is to score the pilot's flight by awarding 100 points for each second of flight when the pilot flies with less than two degrees of deviation from the intended flight path, 80 points for each second of between two and four degrees of deviation, 60 points for between four and six degrees of separate, and so forth, awarding 0 points for greater than 10 degrees of deviation. The scoring can be performed independently for both the horizontal and vertical aspects of the flight path. In FIG. 7, the needles 702, 704 are deflected from the intended instrument approach path and indicate that the pilot is flying the simulated aircraft slightly more than two degrees horizontally and slightly more than two degrees vertically from the intended flight path. In this example, each second the pilot would score 80 points for flying over two degrees, but less than four degrees, horizontally, and 80 points for flying over two degrees, but less than four degrees, vertically from the intended flight path. The scores can be computed for the entire instrument approach and, if necessary, normalized. For example, all of the scores for the horizontal approach can be summed and then divided by the total number of seconds flown to provide a normalized score from 0 to 100. Similarly, all of the scores for the vertical approach can be summed and divided by the total number of second of flight, to provide a normalized the score from 0 to 100 for the vertical aspect of the flight. The two scores can be added together and divided by two in order to derive a normalized score for the ILS approach of between 0 to 100. Other scoring methodologies can be used as would be apparent to one of ordinary skill in the art.

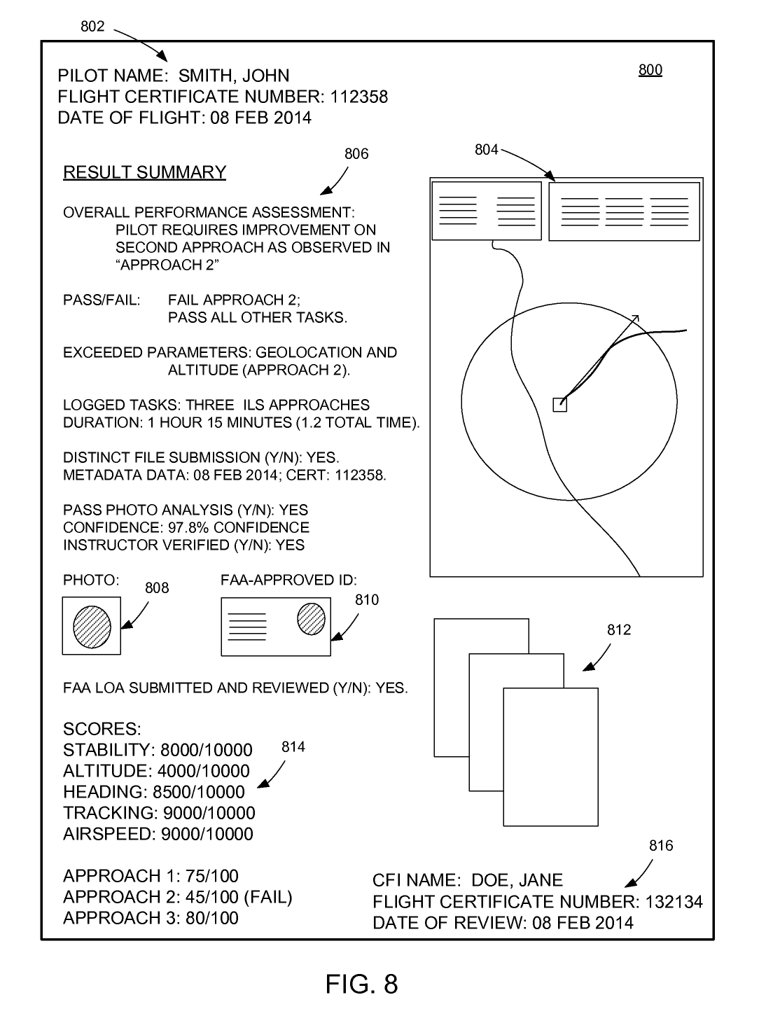

Referring now to FIG. 8, an example report 800 is presented. The report 800 can include identifying indicia 802 about the pilot, such as the pilot's name and pilot certificate number, as well as the date of the flight simulation/training. The report 800 can include a graphic 804 of the flight syllabus that can include a map and a visual representation of the geolocation of the simulated aircraft during the flight. Text can be included with details about the flight syllabus and tasks to be performed, for example the particulars about the airport and information regarding the ILS or other instrument approach parameters.

A result summary 806 can include information about the pilot's performance of the tasks of the flight syllabus. For example, the flight summary can include information added by the automated flight instruction system 100 such as pass/fail information, tasks performed, duration of the flight, results of automated checks of the metadata of the forensic record as described above, and the results of automated comparison of a photo 808 of the pilot with the pilot's FAA-approved identification 810. The result summary 806 can include commentary and other information added by a certified flight instructor. For example the certified flight instructor can indicate whether the certified flight instructor verified the photo against the FAA-approved identification independently of the automated flight instruction system 100, and whether the certified flight instructor reviewed and verified the FAA Letters of Authorization 812 for the flight simulator used by the pilot. Graphic images of the photo 808, FAA-approved identification 810, FAA Letters of Authorization 812, and other suitable images can be presented in the report 800. Links, such as hyperlinks, to the original documents can be embedded in the graphic images.

The report 800 can include automated scoring 814. Example scoring can include scores for stability in flying the simulated aircraft, maintaining altitude, heading, and airspeed, and a score that indicates how well the pilot tracked the intended flight path. Scores for each task, such as individual ILS approach attempts can be separately presented. In a configuration, the report 800 is electronic and can be edited by the certified flight instructor, for example to add commentary or to override scoring or automated pass/fail indications. In a configuration, the certified flight instructor can certify the report 800, and identifying indicia 816 of the certified flight instructor can be added to the report 800, as well as the date that the certified flight instructor reviewed and certified the report 800. The report 800 can be sent to the pilot as described above. In a configuration, a separate written record can be generated from the report 800 by the automated flight instruction system 100 or by the certified flight instructor and sent to the pilot.

In general, it will be apparent to one of ordinary skill in the art that at least some of the embodiments described herein can be implemented in many different embodiments of software, firmware, and/or hardware. The software and firmware code can be executed by a processor or any other similar computing device. The software code or specialized control hardware that can be used to implement embodiments is not limiting. For example, embodiments described herein can be implemented in computer software using any suitable computer software language type, using, for example, conventional or object-oriented techniques. Such software can be stored on any type of suitable computer-readable medium or media, such as, for example, a magnetic or optical storage medium. The operation and behavior of the embodiments can be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on various types of computer-readable media.

It can also be appreciated that certain portions of the processes described herein can be performed using instructions stored on a computer-readable medium or media that direct a computer system to perform the process steps. A computer-readable medium can include, for example, memory devices such as diskettes, compact discs (CDs), digital versatile discs (DVDs), optical disk drives, or hard disk drives. A computer-readable medium can also include memory storage that is physical, virtual, permanent, temporary, semi-permanent, and/or semi-temporary.

A “computer,” “computer system,” “host,” “server,” or “processor” can be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein can include memory for storing certain software modules used in obtaining, processing, and communicating information. It can be appreciated that such memory can be internal or external with respect to operation of the disclosed embodiments.

In various embodiments disclosed herein, a single component can be replaced by multiple components and multiple components can be replaced by a single component to perform a given function or functions. Except where such substitution would not be operative, such substitution is within the intended scope of the embodiments. The computer systems can comprise one or more processors in communication with memory (e.g., RAM or ROM) via one or more data buses. The data buses can carry electrical signals between the processor(s) and the memory. The processor and the memory can comprise electrical circuits that conduct electrical current. Charge states of various components of the circuits, such as solid state transistors of the processor(s) and/or memory circuit(s), can change during operation of the circuits.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

We claim:

1. A computer-implemented method of certifying flight simulator experience, comprising:
recording flight data from a flight simulator during performance of a plurality of flight tasks of a flight syllabus by a pilot;
obtaining a photo of the pilot who performed the flight tasks;
generating a forensic record that includes at least the flight data, and the photo;
authenticating the identity of the pilot using biometric confirmation of the photo;
evaluating the performance of the flight tasks of the fight syllabus using a set of rules and acceptable performance metrics; and
determining a successful completion of the flight training in the flight syllabus by the pilot based at least in part on the success of the authenticating and evaluating operations.

2. The computer-implemented method of claim 1, further comprising:
obtaining Federal Aviation Administration (FAA) compliance information for the flight simulator that shows that the flight simulator meets all limitations and contingencies for the flight training;
confirming the validity of the FAA compliance information for the flight simulator, and
wherein determining the successful completion of the flight training is also based upon the success of the confirming operation.

3. The computer-implemented method of claim 2, wherein the FAA compliance information is selected from the group consisting of an FAA Letter of Authorization (LOA), and a screenshot of a compliance screen from the flight simulator.

4. The computer-implemented method of claim 1, wherein authenticating the identity of the pilot using biometric confirmation of the photo comprises comparing the photo with a picture of the pilot from at least one FAA acceptable form of identification.

5. The computer-implemented method of claim 1, further comprising:
obtaining one or more electronic records that include at least
an FAA pilot certificate of the pilot that includes a pilot certificate number,
an FAA Flight Medical certificate of the pilot, and
a driver license of the pilot; and
authenticating the identity of the pilot using the one or more electronic records.

6. The computer-implemented method of claim 5, wherein authenticating the identity of the pilot further comprises locating a record for the pilot in an FAA Airman Database based at least in part on an identifying indicia of the pilot, wherein the identifying indicia is selected from a pilot name and a pilot certificate number.

7. The computer-implemented method of claim 1, wherein the flight simulator is selected from the group consisting of an FAA-approved Aviation Training Device (ATD), an FAA-approved Flight Training Device (FTD), and an FAA-approved Full Flight Simulator (FFS).

8. The computer-implemented method of claim 1, further comprising:
obtaining a flight syllabus that includes a least one instruction for providing real-time guidance to the pilot during performance of at least one flight task; and
providing real-time guidance to the pilot during performance of a flight task.

9. The computer-implemented method of claim 8, wherein providing real-time guidance to the pilot occurs when the pilot operates the flight simulator outside of one or more flight parameters associated with the flight task.

10. A flight simulator experience certification system, comprising:
a virtual flight data recorder configured to
record flight data from a flight simulator during performance of a flight task of a flight syllabus by a pilot, and
generate a forensic record that includes at least the flight data and a photo of the pilot;
a camera configured to take the photo of the pilot; and
a virtual flight instructor system configured to
authenticate the identity of the pilot using at least the photo,
evaluate the performance of the flight tasks of the fight syllabus by the pilot using a set of rules and performance metrics,
determine a successful completion of a flight task in the flight syllabus by the pilot based at least in part on the success of the authenticate and evaluate operations, and
provide a written record certifying completion of a flight training exercise based at least in part on the successful completion of the flight task in the flight syllabus by the pilot.

11. The flight simulator experience certification system of claim 10, wherein the virtual flight instructor system is further configured to
receive Federal Aviation Administration (FAA) compliance information for the flight simulator that shows that the flight simulator meets all limitation and contingencies, and
confirm the validity of the FAA compliance information for the flight simulator, and
wherein the successful completion of the flight training is also based upon the success of the confirm operation.

12. The flight simulator experience certification system of claim 11, wherein the FAA compliance information is selected from the group consisting of an FAA Letter of Authorization (LOA), and a screenshot of a compliance screen from the flight simulator.

13. The flight simulator experience certification system of claim 10, wherein the virtual flight instructor system is further configured to authenticate the identity of the pilot using one or more FAA acceptable form of identification.

14. The flight simulator experience certification system of claim 10, wherein the flight instructor system is further configured to
receive one or more electronic records that include at least
an FAA pilot certificate of the pilot that has a pilot certificate number,
an FAA Flight Medical certificate of the pilot, and
a driver license of the pilot, and
authenticate the identity of the pilot using the one or more electronic records.

15. The flight simulator experience certification system of claim 14, further comprising:
an authentication server configured to authenticate the identity of the pilot based, at least in part, on identifying indicia of the pilot and a record associated with the pilot in an FAA Airman Database, and
wherein the identifying indicia of the pilot can include one or both of the pilot's name and the pilot certification number.

16. The flight simulator experience certification system of claim 10, further comprising
the flight simulator, and
wherein the flight simulator is selected from the group consisting of an FAA-approved Aviation Training Device (ATD), an FAA-approved Flight Training Device (FTD), and an FAA-approved Full Flight Simulator (FFS).

17. The flight simulator experience certification system of claim 10, further comprising:
a virtual flight instruction means configured to
obtain a flight syllabus that includes a least one instruction for providing real-time guidance to the pilot during performance of at least one flight task; and
provide real-time guidance to the pilot during performance of a flight task.

18. The flight simulator experience certification system of claim 17, wherein the virtual flight instruction means is configured to provide real-time guidance to the pilot when the pilot operates the flight simulator outside of one or more flight parameters associated with the flight task.

19. A non-transitory computer readable medium having instructions stored thereon that when executed by one or more processors causes the processors to:
record flight data from a flight simulator during performance of flight tasks of a flight syllabus by a pilot;
receive a photo of the pilot who performed the flight tasks;
receive one or more electronic records of compliance information selected from the group consisting of
an FAA Letter of Authorization (LOA),
FAA documentation associated with the flight simulator, and
a screen shot of a compliance screen for the flight simulator;
generate a forensic record that includes at least the flight data, the LOA for the flight simulator, and the photo;
validate the LOA for the flight simulator;
authenticate the identity of the pilot using one or more of
a biometric confirmation of the photo using an FAA acceptable form of identification, and
a record associated with the pilot in an FAA Airman Database;
evaluate the performance of the flight tasks against an expected flight path and instrument outputs for the flight tasks; and
send a written record based at least in part on the outcome of the validate, authenticate, and evaluate operations.

20. The non-transitory computer readable medium of claim 19, wherein the instructions further cause the processors to:
receive a flight syllabus that includes a least one instruction for providing real-time guidance to the pilot during performance of at least one flight task; and
provide real-time guidance to the pilot during performance of a flight task when the pilot performs the flight task in such a way that one or more instrument outputs from the flight simulator are different from an expected range of outputs for the flight task.
